(19) United States
(12) Patent Application Publication
(10) Pub. No.: US 2008/0205265 A1
(43) Pub. Date: Aug. 28, 2008

(54) TRAFFIC ROUTING

(75) Inventors: Christopher N. Del Regno, Rowlett, TX (US); Matthew W. Turlington, Richardson, TX (US); Scott R. Kotrla, Wylie, TX (US); Michael U. Bencheck, Richardson, TX (US); Richard C. Schell, Allen, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Irving, TX (US)

(21) Appl. No.: 11/677,699

(22) Filed: Feb. 22, 2007

(51) Int. Cl. G06F 11/00

(52) U.S. Cl. 370/221

(57) ABSTRACT

A method may include forming a primary label switching path (LSP) from a first node to a second node, where the primary LSP has a path metric that is less than a predetermined value. The method may also include detecting a failure in the primary LSP and identifying a second path from the first node to the second node that has a path metric that is less than the predetermined value. The method may further include routing data via the second path in response to the failure in the primary LSP.

### BACKGROUND INFORMATION

Routing data in a network has become increasingly complex due to increased customer bandwidth requirements, increased overall traffic, etc. As a result, network devices often experience congestion related problems and may also fail. Links connecting various network devices may also experience problems and/or fail. When a failure occurs, the traffic must be re-routed to avoid the failed device and/or failed link.

### BRIEF DESCRIPTION OF THE DRAWINGS

FIG. 1 illustrates an exemplary network in which systems and methods described herein may be implemented;

FIG. 2 illustrates an exemplary configuration of a portion of the network of FIG. 1;

FIG. 3 illustrates an exemplary configuration of a network device of FIG. 1;

FIG. 4 is a flow diagram illustrating exemplary processing by various devices illustrated in FIG. 1; and

FIG. 5 illustrates the routing of data via label switching paths in the portion of the network illustrated in FIG. 2.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention. Instead, the scope of the invention is defined by the appended claims and their equivalents.

Implementations described herein relate to network communications and configuring primary paths and alternate paths in a network. When the primary path is not available, data may be re-routed on an alternate path that satisfies a metric associated with the particular user requirements.

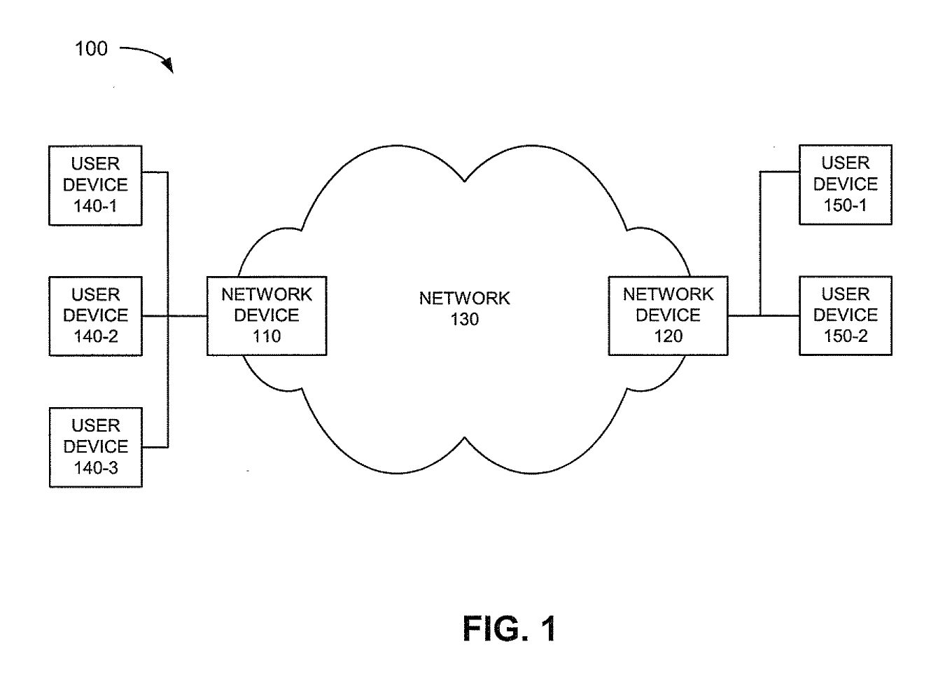

FIG. 1 is a block diagram of an exemplary network 100 in which systems and methods described herein may be implemented. Network 100 may include network device 110, network device 120, network 130, user devices 140-1 through 140-3, referred to collectively as user devices 140, and user devices 150-1 and 150-2, referred to collectively as user devices 150.

Network devices 110 and 120 may each include a network node (e.g., a switch, a router, a gateway, etc.) that receives data and routes the data via network 130 to a destination device. In an exemplary implementation, network devices 110 and 120 may be provider edge (PE) devices that route data received from various devices, such as user devices 140 and 150, using multi-protocol label switching (MPLS). In this case, network devices 110 and 120 may set up a label switching path (LSP) via network 130 in which data forwarding decisions are made using an MPLS label included with a data packet to identify a next hop to which to forward the data. For example, devices in the LSP may receive a data packet that includes an MPLS label in the header of the data packet. The various hops in the LSP may then use the label to identify an output interface on which to forward the data packet without analyzing other portions of the header, such as a destination address.

Network 130 may include a number of devices and links that may be used to connect network device 110 and 120, as described in detail below. In an exemplary implementation, network 130 may include a number of devices used to route data using MPLS. In this implementation, network devices 110 and 120 may represent a head end and tail end, respectively, of an LSP.

Each of user devices 140-1 through 140-3 may represent user equipment, such as customer premises equipment (CPE), customer edge (CE) devices, switches, routers, computers or other devices coupled to network device 110. User devices 140 may connect to network device 110 via wired, wireless or optical communication mechanisms. For example, user devices 140 may connect to network device 110 via a layer 2 network (e.g., an Ethernet network), point-to-point links, the public switched telephone network (PSTN), a wireless network, the Internet or some other mechanism.

Each of user devices 150-1 and 150-2 may represent user equipment similar to user devices 140. That is, user devices 150 may include routers, switches, CPE, CE devices, computers, etc. User devices 150 may connect to network device 120 using wired, wireless or optical communication mechanisms.

The exemplary configuration illustrated in FIG. 1 is provided for simplicity. It should be understood that a typical network may include more or fewer devices than illustrated in FIG. 1. In addition, network device 110 is shown as a separate element from the various user devices 140. In other implementations, the functions performed by network device 110 and one of user devices 140, described in more detail below, may be performed by a single device or node.

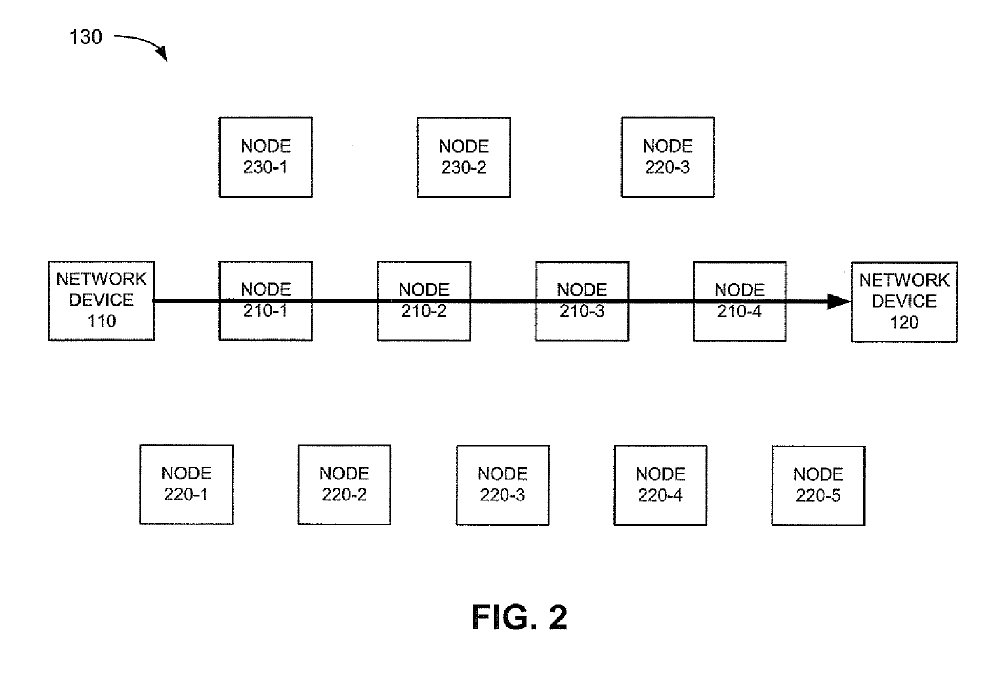

FIG. 2 illustrates an exemplary configuration of a portion of network 130. Referring to FIG. 2, network 130 may include a number of nodes 210-1 through 210-4, referred to collectively as nodes 210, a number of nodes 220-1 through 220-5, referred to collectively as nodes 220, and a number of nodes 230-1 through 230-3, referred to collectively as nodes 230.

Each of nodes 210, 220 and 230 may include a switch, router, or another network device capable of routing data. In an exemplary implementation, nodes 210, 220 and 230 may each represent network devices, such as a router, that is able to route data using MPLS. For example, in one implementation, network device 110 may represent the head end of an LSP to network device 120, which represents the tail end. In this implementation, the LSP from network device 110 to network device 120 may include nodes 210-1 through 210-4, as indicated by the line connecting network device 110 to network device 120 via nodes 210-1 through 210-4. Other LSPs (not shown in FIG. 2) may also be set up to connect network device 110 to network device 120, as described in detail below.

In an exemplary implementation, the LSP connecting network device 110 and 120 may represent a circuit for a particular customer. In some implementations, if the LSP illustrated in FIG. 2 experiences congestion or delays in forwarding data via the LSP, network device 110 may stop routing data via the LSP, as opposed to allowing the LSP to be used with high latency or delay associated with routing the data. In this case, the customer associated with the LSP may effectively allow the LSP to experience down time, as opposed to routing data with higher than desired latency. Network device 110 and/or network device 120 may also identify a new path in network 130 when the latency of an existing path exceeds a predetermined limit, as described in detail below.

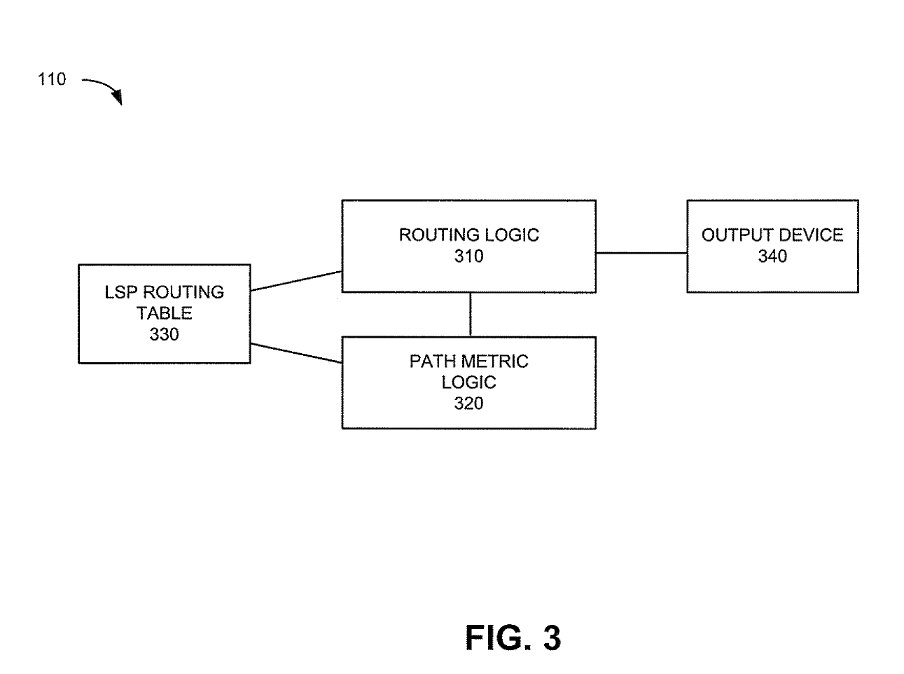

FIG. 3 illustrates an exemplary configuration of network device 110. Network device 120 may be configured in a similar manner. Referring to FIG. 3, network device 110 may include routing logic 310, path metric logic 320, LSP routing table 330 and output device 340.

Routing logic 310 may include a processor, microprocessor, application specific integrated circuit (ASIC), field programmable gate array (FPGA) or another logic device or component that receives a data packet and identifies forwarding information for the data packet. In one implementation, routing logic 310 may identify an MPLS label associated with a data packet and identify a next hop for the data packet using the MPLS label.

Path metric logic 320 may include a processor, microprocessor, ASIC, FPGA or another logic device or component that identifies one or more alternate paths in network 130 that satisfy a particular metric. In an exemplary implementation, the metric may be a sum of the physical distances between each of the nodes in the LSP. The time or latency associated with transmitting data via the LSP is dependent on the physical distances and may be a function of the physical distances between the nodes in the LSP.

In an alternative implementation, the metric may be the actual amount of time for a packet to be transmitted from the head end of an LSP, such as network device 110, to the tail end of the LSP, such as network device 120. In still other implementations, the metric may be a cost associated with transmitting data packets from network device 110 to network device 120 via a number of hops in an LSP. In each case, path metric logic 320 may select an appropriate LSP based on the particular metric, as described in detail below.

LSP routing table 330 may include routing information for LSPs for which network device 110 forms with other devices in network 130. For example, in one implementation, LSP routing table 330 may include an incoming label field, an output interface field and an outgoing label field associated with a number of LSPs that include network device 110. In this case, routing logic 310 may access LSP routing table 330 to search for information corresponding to an incoming label to identify an output interface via which to forward the data packet along with an outgoing label to append to the data packet. Routing logic 310 may also communicate with path metric logic 320 to determine the appropriate LSP, if any, via which to forward the data packet.

Output device 340 may include one or more queues via which the data packet will be output. In one implementation, output device 340 may include a number of queues associated with a number of different interfaces via which network device 110 may forward data packets.

Network device 110, as described briefly above, may determine data forwarding information using labels attached to data packets. Network device 110 may also identify potential alternate paths via which to route data packets. The components in network device 110 may include software instructions contained in a computer-readable medium, such as a memory. A computer-readable medium may be defined as one or more memory devices and/or carrier waves. The software instructions may be read into memory from another computer-readable medium or from another device via a communication interface. The software instructions contained in memory may cause the various logic components to perform processes that will be described later. Alternatively, hardwired circuitry may be used in place of or in combination with software instructions to implement processes consistent with the principles of the invention. Thus, systems and methods described herein are not limited to any specific combination of hardware circuitry and software.

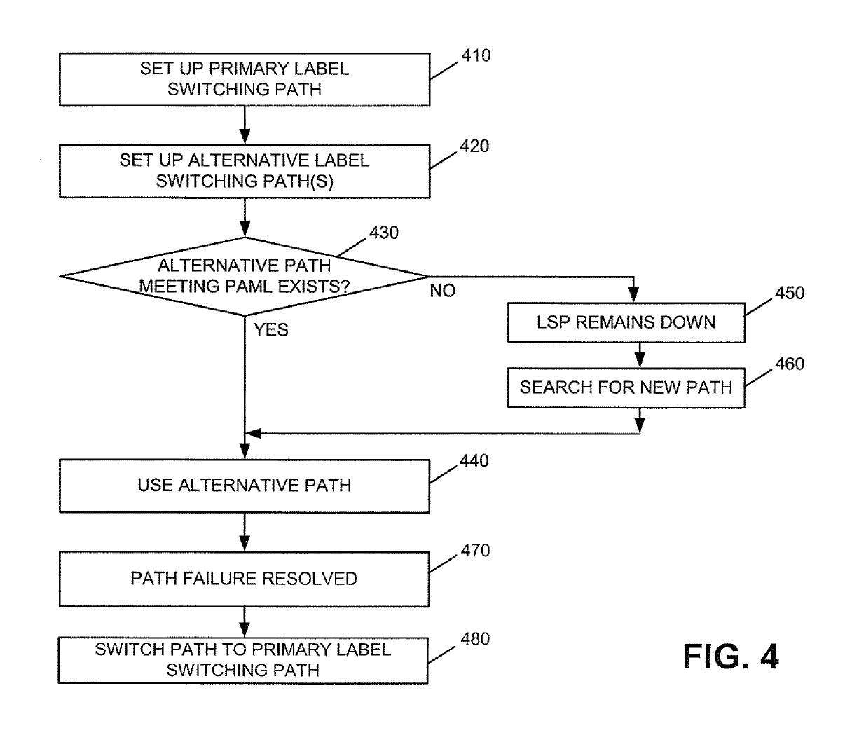

FIG. 4 is a flow diagram illustrating exemplary processing associated with routing data in network 100. In this example, processing may begin with setting up LSPs in network 130 (act 410). In an exemplary implementation, assume that network device 110 wishes to set up an LSP with network device 120 via nodes 210 (FIG. 2). In this case, network device 110 may initiate setting up the LSP by sending a request to set up an LSP with network device 120 that includes label information identifying labels to be used in the LSP and also identifying the destination or tail end of the LSP (i.e., network device 120 in this example). The label information may then be forwarded hop by hop to the other nodes in the LSP. That is, node 210-1 may receive the request for setting up an LSP, store the label information in its memory (e.g., in an LSP routing table) and forward the request and label information to node 210-2, followed by node 210-2 forwarding the request to node 210-3, which forwards the request to node 210-4, which forwards the request to network device 120.

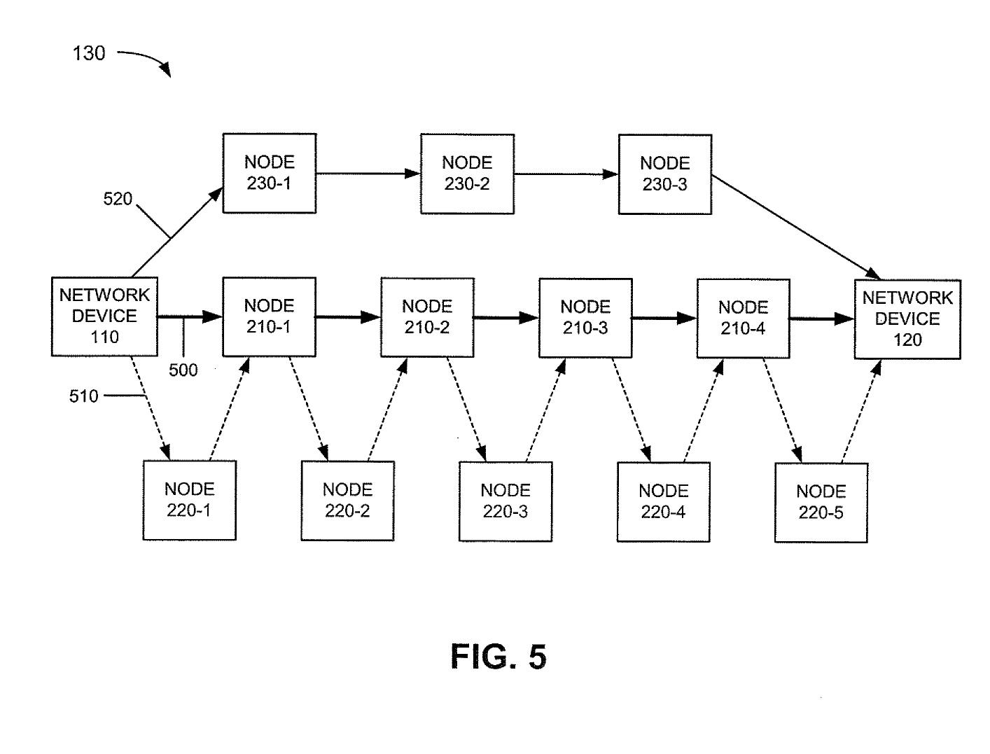

Each of nodes 210 may store the label information in its respective memory, such as an LSP routing table similar to LSP routing table 330. As discussed previously, LSP routing table 330 may include information identifying incoming labels, outgoing interfaces corresponding to the incoming labels and outgoing labels to append to the data packets forwarded to the next hops. After network device 120 receives the request and possibly forwards an acknowledgement back to network device 110, an LSP (the beginning hop of which is labeled 500 in FIG. 5 and referred to herein as LSP 500 or path 500) may be set up from network device 110 to network device 120. Thereafter, when a packet having an MPLS label is received by network device 110, routing logic 310 searches LSP routing table 330 for the label and to identify an outgoing interface on which to forward the packet. Routing logic 310 may also identify an outgoing label in LSP routing table 330 for the data packet and appends the outgoing label to the packet. The outgoing label will then be used by the next hop to identify data forwarding information.

Network device 110 may set up additional LSPs with nodes in network 130 (act 420). For example, network device 110 may set up an another or alternative LSP from network device 110 to network device 120 via nodes 220 and 210 in an alternating manner as illustrated by the dotted line path in FIG. 5 (the first hop of which is labeled 510 in FIG. 5 and is referred to herein as LSP 510 or path 510). In this case, network device 10 may forward the request to set up the LSP along with label information associated with the LSP to node 220-1, which forwards the label information to next hop 210-1, which forwards the label information to next hop 220-2, etc., up through network device 120.

In an exemplary implementation, network device 110 may set up another alternative LSP in network 130 to network device 120 via nodes 230 (the first hop of which is labeled 520 in FIG. 5 and is referred to herein as LSP 520 or path 520). In this case, network device 110 may forward the request to set up the LSP along with label information associated with the LSP to node 230-1, which forwards the label information to next hop 230-2, which forwards the label information to next hop 230-3, which forwards the label information to network device 120.

After LSPs 500, 510 and 520 have been set up, routing logic 310 may designate path 500 as the primary LSP to use when routing data to network device 120. Routing logic 310 may also designate LSPs 510 and 520 as alternate paths.

Assume that data is being routed in network 100 using LSP 500. Further assume that the data being transmitted from network device 110 to network device 120 must be transmitted such that a path metric associated with transmitting the data via LSP 500 must meet a predetermined path metric. For example, assume that the path metric is the sum of the physical distances between each of the hops in LSP 500. As discussed previously, the total time for transmitting the data from network device 110 to network device 120 may be a function of distance between hops.

In this example, assume that network device 110 (and possibly other nodes in network 130) may store distance information identifying physical distances (or values representing physical distances) between itself and various other nodes in network 130. For example, network device 110 may store information identifying the distance to node 210-1, the distance to node 220-1 and the distance to node 230-1. Network device 110 may also store information identifying physical distances between other nodes, such as the distance between nodes 210-1 and 210-2, the distance between node 210-2 and 210-3, the distance between node 220-1 and 210-1, etc. In this example, assume that the distance between each hop in LSP 500 corresponds to a value of 10. That is, the physical distances may be assigned values that correspond to the physical distances. In this case, the total value is 50 since there are five hops each having a value of 10 in LSP 500. Further assume that the maximum path accumulated metric limit (PAML) (e.g., a value that LSP 500 must not exceed) for an LSP from network device 110 to network device 120 is 150. It should be understood that the particular PAML may be higher or lower based on the particular requirements associated with, for example, a customer associated with the LSP from network device 110 to network device 120. For example, a customer associated with user devices 140-1 may want to ensure that data transmitted via network 130 is transmitted within a guaranteed time. In this case, the customer and the entity associated with network 130 may have negotiated a guaranteed service level agreement (SLA) regarding the transmission times.

Assume that LSP 500 experiences a failure. For example, a link connecting two of the hops in LSP 500 may fail, one of nodes 210 may fail, etc. Network device 110 may detect this failure based on, for example, a lack of an acknowledgement message with respect to a signal transmitted to node 210-1, a time out associated with a handshaking signal or some other failure indication associated with LSP 500.

Path metric logic 320 may then identify whether an alternative path is available that has a path metric that is less than the PAML (act 430). For example, path metric logic 320 may determine for path 510 that each link between the hops in path 510 has a path metric value of 50. In this case, path metric logic 320 determines that the total path metric associated with path 510 is 500 (i.e., 10 links at a value of 50 each), which is greater than the PAML value of 150 in this example. Therefore, path metric logic 320 does not signal routing logic 310 to use path 510.

Path metric logic 320 may then check the path metric associated with path 520. In this case, assume that the path metric logic 320 determines that the metric associated with each link in path 520 is equal to a value of 25 for a total path metric value of 100. In this case, the path metric value is less than the PAML of 150. Path metric logic 320 may then signal routing logic 310 to use path 520 (act 440). The LSP associated corresponding to path 520 may then be established as described above. In other instances, LSP 520 may have been previously established.

Network device 110 may then begin routing data to network device 120 via LSP 520. In this manner, path metric logic 320 may identify a path or LSP that meets the PAML for use by network device 110.

In the event that path metric logic 320 is unable to identify a path that meets the PAML, network device 110 may allow the path from network device 110 to network device 120 to remain down (act 450). That is, a particular client associated with LSP 500 may prefer that their connection/service remain in a “hard failure” state as opposed to routing data from network device 110 to network device 120 via another path (e.g., path 510) that has too much delay or latency associated with transmitting data from network device 110 to network device 120.

Path metric logic 320 may also continue to search for another path using, for example, a constraint-based shortest path first (CSPF) algorithm (act 460). In this case, the CSPF algorithm attempts to identify a path that satisfies the PAML. If path metric logic 320 identifies such a path, path metric logic 320 may signal routing logic to use that path (act 440).

In alternative implementations, however, network device 110 and/or nodes in network 130 may be configured to perform a fast re-route function in which if a link or path is down, the node is configured to identify an alternate path to forward the particular data packet. In this case, no pre-provisioned backup LSP (e.g., LSP 510 or LSP 520) may be necessary. For example, if the first link in LSP 500 is down, network device 110 may automatically signal node 220-1 and/or 230-1 that a fast reroute operation is to occur and to set up an LSP to network device 120 based on link availability. The other nodes in network 130 may be similarly configured to perform a fast re-route operation so that the data from network device 110 may be forwarded hop by hop to network device 120. In this manner, an LSP may be quickly formed (e.g., within 50 milliseconds or less) from network device 110 to network device 120.

In each case (i.e., an alternative path/LSP is identified, a fast re-route is performed, or the LSP remains in a hard fail state), assume that the failure or problem associated with LSP 500 is resolved (act 470). That, is the primary LSP 500 becomes available for routing data from network device 110 to network device 120 such that the PAML is less than the predetermined value. In this case, routing logic 310 may switch from the alternative LSP (i.e., LSP 520 in this example) back to LSP 500 (act 480). In addition, routing logic 310 may switch to LSP 500 in a “make before break” manner. That is, routing logic 310 may switch back to LSP 500 while ensuring that no data packets are dropped while, for example, waiting for LSP 500 to be re-initialized and/or ready to receive/transmit data

In the examples above, the switch from the primary to backup LSP was described as being caused by a link failure and/or device failure. In other instances, the switch may occur due to congestion and/or latency problems associated with a particular device/portion of the LSP. That is, if a particular portion of an LSP is experiencing latency problems that may, for example, make it unable to provide a desired service level, such as a guaranteed level of service associated with a service level agreement (SLA), network device 110 or another device in network 100 may signal network device 110 to switch to a backup LSP. In each case, when the problem is resolved (e.g., latency, failure, etc.), network device 110 may switch back to the primary LSP. In this manner, routing in network 100 may be optimized.

Implementations described herein provide for routing data within a network via a primary path or a backup path. The paths may be LSPs that meet particular requirements or metrics associated with routing data from one device to another.

The foregoing description of exemplary implementations provides illustration and description, but is not intended to be exhaustive or to limit the invention to the precise form disclosed. Modifications and variations are possible in light of the above teachings or may be acquired from practice of the invention.

For example, various features have been described above with respect to network device 110 identifying an LSP on which to route data. In other implementations, a control node in network 130 may identify the LSP on which to route data.

In addition, features have been mainly described herein with respect to identifying a particular path that satisfies a PAML associated with physical distances between hops in an LSP. In other implementations, the PAML may be an actual time associated with data transmitted via an LSP. In such implementations, path metric logic 320 or another device in network 130 may determine the total time associated with data transmitted from network device 110 to network device 120 by, for example, periodically injecting test packets onto LSP 500 and monitoring when they are received by network device 120, such as via a response message from network device 120. In other implementations, one or monitoring devices network 130 may track the actual propagation time associated with transmitting real customer traffic via LSP 500.

For example, time tags may be included in the data packets transmitted from network device 110. Each node along LSP 500 may determine a propagation time based on when the data packet is received and the total propagation time may be determined by totaling the individual propagation times for each link in LSP 500. For example, if each of the five links in LSP 500 has a propagation time of 30 milliseconds, path metric logic 320 may determine that the total propagation time via LSP 500 is 150 milliseconds. In this case, the PAML may be a value that represents an actual time.

In still other implementations, the PAML may be associated with a cost for transmitting data packets. In this case, each link in network 130 may have an associated cost for transmitting data via that link. Network device 10 may then identify an LSP in which the total cost associated with that LSP is less than the PAML.

In addition, while series of acts have been described with respect to FIG. 4, the order of the acts may be varied in other implementations. Moreover, non-dependent acts may be implemented in parallel.

It will be apparent to one of ordinary skill in the art that various features described above may be implemented in many different forms of software, firmware, and hardware in the implementations illustrated in the figures. The actual software code or specialized control hardware used to implement the various features is not limiting of the invention. Thus, the operation and behavior of the features of the invention were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as a processor, a microprocessor, an application specific integrated circuit, or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
forming a primary label switching path (LSP) from a first node to a second node, wherein a path metric associated with the primary LSP is less than a predetermined value;
detecting a failure in the primary LSP;
identifying a second path from the first node to the second node, wherein a path metric associated with the second path is less than the predetermined value; and
routing data via the second path in response to the failure in the primary LSP.

2. The method of claim 1, further comprising:
detecting a recovery in the primary LSP; and
automatically switching back to routing data on the primary LSP in response to the recovery.

3. The method of claim 1, wherein the primary LSP includes a plurality of nodes and a plurality of links, each of the plurality of links coupling two of the plurality of nodes to each other, wherein the predetermined value comprises:
a value generated by summing a distance associated with each of the plurality of links.

4. The method of claim 1, wherein the identifying a second path comprises:
summing values associated with each of a plurality of links in the second path to generate a first value, and
determining whether the first value is less than the predetermined value.

5. The method of claim 4, wherein the values correspond to a distance for each of the plurality of links.

6. The method of claim 4, wherein the values correspond to a time or latency associated with routing data via each of the plurality of links.

7. The method of claim 4, wherein the values correspond to a cost associated with routing data via each of the plurality of links.

8. The method of claim 1, further comprising:
allowing a link from the first node to the second node to remain in a down state when a path having a path metric less than the predetermined value cannot be identified.

9. A first network device, comprising:
logic configured to:
route a data packet via a first label switching path (LSP) to a second network device,
identify a problem in the first LSP,
determine whether a second path from the first network device to the second network exists, the second path having a path metric that is less than a predetermined value, and
route data via the second path in response to the identified problem, when a second path exists.

10. The first network device of claim 9, wherein the logic is further configured to:
detect a recovery in the first LSP, and
automatically switch back to routing data on the first LSP in response to the recovery.

11. The first network device of claim 9, wherein when determining whether a second path exists, the logic is configured to:
sum values associated with each of a plurality of links from the first network device to the second network device to determine whether the second path has a path metric less than the predetermined value.

12. The first network device of claim 11, wherein the values correspond to physical distances associated with each of the plurality of links.

13. The first network device of claim 11, wherein the values correspond to a time associated with routing data via each of the plurality of links.

14. The first network device of claim 11, wherein the values correspond to a cost associated with routing data via each of the plurality of links.

15. The first network device of claim 11, wherein the logic is further configured to:
prohibit routing of data from the first network device to the second network device when a second path from the first network device to the second network device and having a path metric less than the predetermined value does not exist.

16. A method, comprising:
setting up a first label switching path (LSP) from a first node to a second node, the first LSP having a path metric less than a predetermined value;
detecting a failure in the first LSP; and
determining whether a second path from the first node to the second node and having a path metric less than the predetermined value exists, wherein the predetermined value corresponds to at least one of a distance, time or cost associated with routing data.

17. The method of claim 16, further comprising:
stopping routing of data on the first LSP in response to the failure;
detecting a recovery in the first LSP; and
automatically routing data on the first LSP in response to the recovery.

18. The method of claim 16, wherein the determining whether a second path from the first node to the second node and having a path metric less than the predetermined value exists comprises:
summing values corresponding to distances associated with links in the second path, and
determining whether the summed values are less than the predetermined value.

19. The method of claim 16, wherein the determining whether a second path from the first node to the second node and having a path metric less than the predetermined value exists comprises:
summing values corresponding to times associated with transmitting data via links in the second path, and
determining whether the summed values are less than the predetermined value.

20. The method of claim 16, wherein the determining whether a second path from the first node to the second node and having a path metric less than the predetermined value exists comprises:
summing values corresponding to costs associated with transmitting data via links in the second path, and
determining whether the summed values are less than the predetermined value.
